(19) United States
(12) Patent Application Publication
(10) Pub. No.: US 2025/0306538 A1
(43) Pub. Date: Oct. 2, 2025

(54) CHRONOGRAPH-WATCH

(71) Applicant: LVMH Swiss Manufactures SA, La Chaux-de-Fonds (CH)

(72) Inventors: Stéphane Calame, Lajoux (CH); Yannick Chatelain, Villers-Le-Lac (FR); Bruno Devevey, Les Fourgs (FR)

(21) Appl. No.: 18/866,124

(22) PCT Filed: May 16, 2023
(86) PCT No.: PCT/IB2023/055014

§ 371 Date: Nov. 15, 2024

(30) Foreign Application Priority Data
May 16, 2022 (CH) CH000591/2022
May 16, 2022 (FR) FR2204635

(51) Int. Cl. G04F 7/08

(52) U.S. Cl. CPC G04F 7/0866; G04F 7/0804

(57) ABSTRACT

The present disclosure relates to a chronograph-watch comprising a timepiece mechanism. The timepiece mechanism includes: a current time mobile comprising an axis and being arranged to rotate about this axis, a first mobile comprising an axis and being arranged to be connected to the current time mobile, an indicator member, a second mobile arranged to mesh with the first mobile and to be connected to the said indicator member, an element bearing a scale comprising a set of indications, the indicator member allowing information to be displayed on this scale. The mobiles are arranged so as to obtain a gear ratio between the mobiles which varies as a function of their relative angular position, so that the indicator member rotates with a variable rotational speed in correspondence with at least one subset of said set of indications.

### TECHNICAL AREA

The present invention relates to a chronograph-watch, in particular a chronograph-watch comprising a timepiece mechanism which allows an indicator member to rotate with a variable speed.

### STATE OF THE ART

A watch in general comprises a kinematic chain linking a source of energy, for example and in a non-limitative way a barrel, to one or several current time mobiles, which are connected, directly or indirectly (for example via one or several intermediate mobiles) to one or several indicator members of the watch (such as for example and in a non-limitative way hands), in order to display the current hour, minutes and/or seconds. The current time mobiles are therefore arranged to rotate continuously with a constant speed.

A chronograph-watch is a timepiece that measures time. Generally, it has at least one indicator member which can be started and stopped by means of a push-button or other control device in order to measure a time. It can then be returned to its starting point. Many chronographs also include indicator members for displaying the current time in addition to the measured time.

When a push-button (or other control device) of a chronograph-watch is pressed for the first time, the indicator member, which is at rest at an initial time indication of a first set of time indications generally carried by a dial, starts to move (“start”). A second press on the same push-button or on another push-button has the effect of stopping the indicator member at the precise point at which it was at the time it was pressed (“stop”). A third press on the same or another push-button quickly returns the indicator member to its starting point, i.e. to the initial time indication (“reset”). In this way, it is possible to measure a time duration.

In this context, the term “indication” indicates a sign, such as a line, a number, a letter, a symbol and/or a combination of these, carried by an element of the watch, such as a dial or a bezel.

Some known chronograph-watches, in particular wristwatches, also include a second set of non-temporal or auxiliary indications, such as tachometric, pulsometric or telemetric indications, which are also carried by an element of the watch, such as a bezel or dial. As with the set of time indications, this set of auxiliary indications generally also includes an initial auxiliary indication, a final auxiliary indication and possible intermediate auxiliary indications between the two.

The indicator member, which is connected to a counter wheel for a given time, for example a chronograph seconds, chronograph minutes or chronograph hours wheel, is generally at rest. When a user actuates a control device of the chronograph-watch, for example a push-button, it starts a rotation of this indicator member.

In known solutions, the speed of rotation of the indicator member is constant. The user stops the movement of this indicator member, for example with the same push-button, when a condition is satisfied. The indicator member thus stops at an auxiliary indication, or between two adjacent auxiliary indications. The user can thus read information corresponding to the stop position of the indicator member.

If the chronograph-watch has a tachometric scale, this condition for stopping the indicator member is generally a certain distance covered by a person or a moving object as soon as the push-button of the chronograph-watch is actuated. The moving object may, for example, be a vehicle such as a car, particularly a sport car. For example, this distance may be 100 m or 1000 m. The user can thus read the speed of the person or object in motion corresponding to the stop position of the indicator member on the scale.

If the chronograph-watch has a pulsometric scale, this stop condition of the indicator member is generally a certain number of heartbeats counted by the user, as soon as the push-button of the chronograph-watch is pressed, for example and without limitation 15 or 30 heartbeats. The user can thus read his own heart rate or that of another person corresponding to the stop position of the indicator member on the scale.

If the chronograph-watch with a telemetric scale, this condition for stopping the indicator member is generally the hearing of a sound related to an event, the rotation of the indicator member having been started by the user when viewing this event. A telemetric scale allows to calculate the distance between an observer wearing the watch and a given point where this event takes place, by means of the speed of sound (approximately 340 m/s), by comparing the vision of an event and the time taken for the sound to be heard by the user. The indicator member is thus stopped at a certain indication on the telemetry scale. At this indication, the user can read the distance separating him from this given point. This distance can be, for example, the user's distance from a flash of lightning or the distance separating several troops based on the shots or detonations heard, for example.

In most known solutions, the scale of time indications has a distance between one time indication and the next which is substantially constant over the whole set of time indications. In other words, in most known solutions, the time scale has a constant resolution.

In some of the known solutions, the scale of auxiliary indications (for example the tachometric, pulsometric or telemetric scale) also has a distance between one auxiliary indication and the next one which is substantially constant over the whole set of auxiliary indications.

In general, a time or auxiliary indication scale with a constant distance between one indication and the next and of reasonable length is easy for the user to read.

A scale with a constant distance between one indication and the next, in combination with the indicator member rotating at a constant speed, allows the user to read information (time or auxiliary) with the same level of detail across all the indications (time or auxiliary). However, depending on the application, there may be a need for more (or less) detailed (or precise) information for one or more subsets of all the indications on the scale concerned.

If one considers a scale of time indications, for example the measured seconds scale, it may be interesting to read more precise information around certain subsets of the time indications, for example in the subset of the first 10 seconds or 15 measured seconds, compared with other subsets.

This requirement also applies to certain auxiliary indication scales.

For example, an athlete's heart rate under stress is around 180 beats per minute. It can therefore be interesting to read more precise information corresponding to a sub-set around this heart rate.

Alternatively, a racing car may arrive at a high speed, for example around 200 km/h or more, after covering a predetermined distance, for example 1000 m. It may therefore be interesting to read more precise information corresponding to a subset around this speed.

A scale (with time or auxiliary indications) with a constant distance between one indication and the next, in combination with the indicator member which rotates at a constant speed, therefore generally allows the user a good reading of the information, but it does not allow to prioritize certain subsets of the set of indications (time or auxiliary) which are of interest for a particular application over other subsets.

In some known solutions, the scale bearing the auxiliary indications has a variable distance between one auxiliary indication and the next, i.e. a distance that is not constant over all the auxiliary indications. In these solutions, the indicator member, which is generally the measured seconds indicator member, rotates at a constant speed.

Although this solution allows to prioritise certain subsets of the set of auxiliary indications which are of interest for the application envisaged, over other subsets, by using a variable distance between an auxiliary indication and the next one, the readability of the information is not satisfactory. In fact, some of the distances between an auxiliary indication and the successive indication on the scale are too small to be easily read. Furthermore, if the indicator member stops between two adjacent indications separated by too short a distance, the read information may not be sufficiently accurate for the intended application.

Document ITBG20090056A1 describes a timepiece mechanism that displays the current time with a hand that rotates at a variable speed. The mechanism comprises a first wheel (reference 7A), which is integral with a second wheel (reference 7B), smaller and arranged on another plane. The first wheel and the second wheel rotate around a drive shaft. The first wheel meshes with the portion of a third wheel (reference 7C) which is integral with the portion of a fourth wheel (reference 7D), smaller and arranged on the same plane as the second wheel. When the first wheel no longer meshes with the third wheel, the second wheel meshes with the fourth wheel. This document indicates that the transition between the two gears (first wheel-third wheel and second wheel-fourth wheel) must be carefully made.

Document JP407209440 relates to a timepiece mechanism that enables the current time to be displayed with a hand that rotates at a variable speed. The mechanism comprises a gear with elliptical wheels, which connect a motor shaft to a hand shaft.

Document EP2945029 relates to an anti-shock clutch device comprising a clutch wheel arranged to hold an engaged position and a disengaged position, a clutch member and a clutch cam cooperating with the clutch member to define the engaged position and the disengaged position of the clutch wheel.

Document U.S. Pat. No. 490,123 concerns a chronograph mechanism clutched to counting the current time.

Document DE1949177U relates to a pulsometer, having a scale bearing indications at a variable distance between an auxiliary indication and the next one. The hand rotates at a constant speed.

Document CH703579, in the name of the applicant, concerns a start, stop and reset system for a mechanical chronograph-watch.

### BRIEF SUMMARY OF THE INVENTION

One aim of the present invention is to offer a chronograph-watch that is free from the limitations of known chronograph-watches.

Another aim of the invention is to offer a chronograph-watch that enables the user to obtain more or less precise information (i.e. with improved resolution) for one or more subsets of the desired set of indications, with better readability than known solutions.

Another aim of the invention is to offer a chronograph-watch alternative to known solutions.

According to the invention, these aims are achieved in particular by means of the chronograph-watch according to claim 1.

The chronograph-watch according to the invention comprises a timepiece mechanism, the timepiece mechanism comprising:
a current time mobile, comprising an axis and being arranged to rotate (permanently) about this axis,
a first mobile, comprising a first axis and being arranged to be connected to the current time mobile and to rotate about this first axis with a constant speed of rotation,
an indicator member,
a second mobile, arranged to mesh with the first mobile, and to be connected to the indicator member,
an element bearing a scale comprising a set of indications, this indicator member enabling information, for example time or auxiliary information, to be displayed on this scale.

In this context, the term “mobile” indicates a watch component that moves or shifts, in particular with a rotational movement around an axis. In this context, a mobile can be a wheel, a cam, etc.

According to the invention, the first mobile and the second mobile are arranged to obtain a gear ratio between the first mobile and the second mobile that varies as a function of their relative angular position, so that the indicator member rotates with a variable speed of rotation at at least one subset of the set of indications of the scale.

Thanks to the fact that the indicator member rotates at a variable speed of rotation, at at least one subset of the set of indications of the scale, it is possible to design several scales which are more readable compared with known solutions, while allowing more (or less) detailed (or more or less precise, i.e. with a better or worse resolution) information to be displayed for one or more subsets of the set of indications concerned.

For example, it is possible to use a scale with a constant distance between one indication and the next throughout the set of indications on the scale. Instead of using a scale with a distance between one indication and the next that is variable, which cooperates with an indicator member that rotates at a constant speed of rotation, the mechanism according to the invention allows to use a scale with a constant distance, and therefore more readable, since the indicator member rotates at a variable speed of rotation.

It is also possible to use a scale with a variable distance between one indication and the next, at least for a subset of the set of indications in the scale. This scale, combined with the variable rotation speed of the mechanism according to the invention, allows to have—in correspondence with the subsets of indications of interest for the desired application—(variable) distances between one indication and the next which are larger than the corresponding distances of the known solutions, which allows a better readability and better resolution of the desired information compared with the known solutions. This scale, combined with the variable speed of rotation of the mechanism according to the invention, also allows to have—in correspondence with subsets of indications that are not of interest for the application envisaged-(variable) distances between one indication and the next that have smaller dimensions than the corresponding distances of the known solutions.

In one embodiment, the scale carries time indications, for example indications of the seconds, minutes or hours of the current time, or indications of measured seconds, minutes or hours.

In one embodiment, the scale carries auxiliary indications, for example the scale is a tachometric, pulsometric or telemetric scale.

In one embodiment, the timepiece mechanism carries both at least one scale bearing time indications and at least one scale bearing auxiliary indications, the two scales cooperating with the same indicator member which rotates at a variable speed, so that the user can read a time respectively an auxiliary indication.

The auxiliary indications scale can be carried by the same element that carries the time indications scale (for example, a dial can carry both scales), or it can be carried by another element (for example, the dial can carry the time indications scale and the bezel the auxiliary indications scale).

According to the invention, the timepiece mechanism comprises: —an actuating device, and
a clutch mechanism, arranged so as to be able to connect the current time mobile with the first mobile under the action of the actuating device.

In one embodiment, the mechanism comprises an input mobile, comprising an input axis and being arranged to rotate about this input axis, the input mobile being arranged to be driven in rotation by the current time mobile. In this embodiment, the clutch mechanism is arranged to connect, under the action of the actuating device, the current time mobile with the first mobile via the input mobile.

In one embodiment, the first mobile and the second mobile have the same shape defined by radii of different lengths, the first mobile and the second mobile being arranged so that the sum of the radii of each mobile in correspondence of the gearing of the two mobiles is constant, the sum of these radii being equal to the inter-axis of the two mobiles.

In one embodiment, the sum of these radii belongs to the range 3 mm to 8 mm, preferably 5 mm to 6 mm, in particular 5.436 mm to 5.450 mm.

In one embodiment, the first mobile and the second mobile have the same perimeter. In another embodiment, the perimeter of the first mobile is a multiple of the perimeter of the second mobile. In another embodiment, the perimeter of the second mobile is a multiple of the perimeter of the first mobile.

In this context, the expression “perimeter of a mobile” refers to the primitive (or reference) perimeter of this mobile.

In one embodiment, the subset of scale indications in which the indicator member rotates with a variable speed of rotation is a first subset of the set of indications, the set comprising a second subset distinct from the first subset, each of the first mobile and second mobile is arranged so that the rotation of the second mobile remains constant in correspondence with the second subset of scale indications.

In one embodiment, each of the first mobile and second mobile has the same shape (or profile).

In one embodiment, each of the first and second mobile is a cam having a spiral shape.

In one embodiment, each of the first mobile and second mobile has a logarithmic spiral shape, i.e. the shape defined by the vertices of the teeth of each mobile is a portion of a logarithmic spiral. In one embodiment, this logarithmic spiral shape is the same for the first mobile and the second mobile.

The logarithmic spiral shape of each mobile allows to limit variations in the speed of the indicator member, particularly for a given period, for example less than 1 minute from the moment it starts up. The curve of the speed of the indicator member as a function of time in this period is therefore a smooth curve, with no peaks. The logarithmic spiral shape of each mobile also gives a logarithmic curve of the torque of the indicator member as a function of time, and therefore without peaks.

In one embodiment, each of the first mobile and the second mobile comprises an mobile body and toothing.

In one embodiment, each of the first mobile and the second mobile comprises at least one recess, in order to reduce its unbalance when the indicator member is reset.

In one embodiment, each mobile having a logarithmic spiral shape comprises a first recess and a second recess.

In one embodiment, the first recess is defined by a first proximal portion of the body of the mobile, namely a portion close to the axis of rotation of the mobile, by a first portion of the toothing of the mobile and by a first arm, the first arm connecting one end of the first proximal portion of the body of the mobile to one end of the first portion of the toothing of the mobile.

In one embodiment, the second recess is defined by a second proximal portion of the body of the mobile (adjacent to the first proximal portion), by the first arm, by a second portion of the toothing of the mobile and by a second arm, the second arm connecting an end of the toothing to an end of the second proximal portion of the body of the mobile.

In one embodiment, the shape and/or dimensions of the first recess of the first mobile is/are different from the shape and/or dimensions of the first recess of the second mobile. In one embodiment, the shape and/or dimensions of the second recess of the first mobile is/are different from the shape and/or dimensions of the second recess of the second mobile.

In one embodiment, the shape and/or dimensions of the first arm of the first mobile is/are different from the shape and/or dimensions of the first arm of the second mobile. In one embodiment, the shape and/or dimensions of the second arm of the first mobile is/are different from the shape and/or dimensions of the second arm of the second mobile.

The logarithmic spiral shape of each mobile also allows to have a greater maximum value of torque (of the driven mobile) compared with the maximum value of torque obtained with a circular shape of each mobile. In one embodiment, the logarithmic spiral shape of each mobile also allows to have a maximum value of the rotational torque (of the driven mobile) that is three times that obtained with a circular shape of each mobile.

In one embodiment, when the user starts the indicator member reset, the second mobile is no longer a driven mobile, but becomes a driving mobile. During the reset, the second mobile leads the first mobile and, via the first mobile, also the input mobile.

In one embodiment, the timepiece mechanism comprises a heart piece coaxial with the second mobile.

The maximum value of the torque of the larger driven mobile obtained by the logarithmic spiral shape of the mobiles, combined with the friction of the input mobile, can cause a disengagement between the second mobile and the heart piece, thus creating an offset between the rotation of the heart piece and that of the second mobile and therefore an offset of the indicator member in relation to the dial when the timepiece mechanism is activated at start-up.

In one embodiment, the timepiece mechanism therefore comprises a connecting means between the second mobile and the heart piece, enabling them to be made integral, and therefore reducing or avoiding any shift caused during the reset. In one embodiment, this connecting means comprises a pin carried by the heart piece and arranged to be received by a through hole in the second mobile. In one embodiment, the first arm of the second mobile comprises this through hole. In one embodiment, this through hole is also a means of indexing the heart piece.

In another embodiment, the second mobile and the heart piece constitute a monobloc piece, i.e. a piece realized in a monolithic way. This also allows to secure the second mobile to the heart piece, and therefore avoid any displacement caused during the reset.

In one embodiment, the shape of the heart piece is optimised to compensate for the effects of the logarithmic spiral shape of the second mobile, to enable the indicator member to be reset.

In one embodiment, the second mobile and/or the heart piece comprises a heart piece indexing means, for example a through hole.

If there is (angular) play between the two mobiles, which allows the second mobile to rotate before it is driven by the first mobile, it is possible to observe a backward movement of the indicator member at the start of the chronograph-watch, in particular a backward movement of the order of magnitude of a few degrees (e.g. 3.5°) counter-clockwise with respect to the starting position of the indicator member.

In order to reduce or eliminate this play, in one embodiment the timepiece mechanism also comprises play-limiting means between the two mobiles. In one embodiment, the second mobile comprises this play-limiting means. In one embodiment, the second arm of the second mobile comprises this play-limiting means. In one embodiment, this play-limiting means comprises a protrusion of an arm of the second mobile, in particular of the second arm of the second mobile.

In one embodiment, the toothing of the first mobile and/or the second mobile are arranged to reduce an overlapping of the indicator member.

In one embodiment, the element of the timepiece mechanism according to the invention is a dial or a portion of the dial.

In one embodiment, the element of the timepiece mechanism according to the invention is a bezel or a portion of a bezel.

### BRIEF DESCRIPTION OF THE FIGURES

Examples of embodiments of the invention are shown in the description illustrated by the attached figures in which:

FIG. 1 shows a top view of part of a movement for one embodiment of the chronograph-watch according to the invention.

FIG. 2 shows a perspective view of part of the timepiece mechanism of the chronograph-watch of FIG. 1.

FIG. 3 shows a bottom view of the timepiece mechanism of FIG. 2.

FIG. 4 illustrates a top view of a timepiece mechanism according to another embodiment of the chronograph-watch.

FIG. 5A is a graph illustrating the variation over time of the speed of rotation of the indicator member of the timepiece mechanism according to one embodiment of the invention, compared with the constant speed of known solutions.

FIGS. 5B and 5C are also graphs illustrating the variation over time of the speed of rotation of the indicator member of the timepiece mechanism according to other embodiments of the invention.

FIG. 6 illustrates a top view of a scale of one embodiment of the timepiece mechanism of the chronograph-watch according to the invention, in particular a 100 m tachometer scale with a variable distance between an auxiliary indication and the next one.

FIG. 7 illustrates a top view of one embodiment of a scale of the timepiece mechanism of the chronograph-watch according to the invention, in particular a 1000 m tachometer scale with a variable distance between an auxiliary indication and the next one.

FIG. 8 illustrates a top view of a scale of one embodiment of the timepiece mechanism of the chronograph-watch according to the invention, in particular a pulsometric scale for 30 pulses with a variable distance between an auxiliary indication and the next one.

FIG. 9 illustrates a top view of one embodiment of a scale of the timepiece mechanism of the chronograph-watch according to the invention, in particular a pulsometric scale for 15 pulses with a variable distance between an auxiliary indication and the next one.

FIG. 10 illustrates a top view of one embodiment of a scale of the timepiece mechanism of the chronograph-watch according to the invention, in particular a telemetric scale with a variable distance between an auxiliary indication and the next one.

### Example(s) of Embodiment(s) of the Invention

In the following description provided by way of example, reference will be made to scales comprising a plurality of indications, the distance between one indication and the next one being variable at least for a subset of the set of indications. It should be understood, however, that the invention is not limited to these embodiments, but also includes timepiece mechanisms comprising scales with several indications, the distance between one indication and the next one being constant for the entire set of indications.

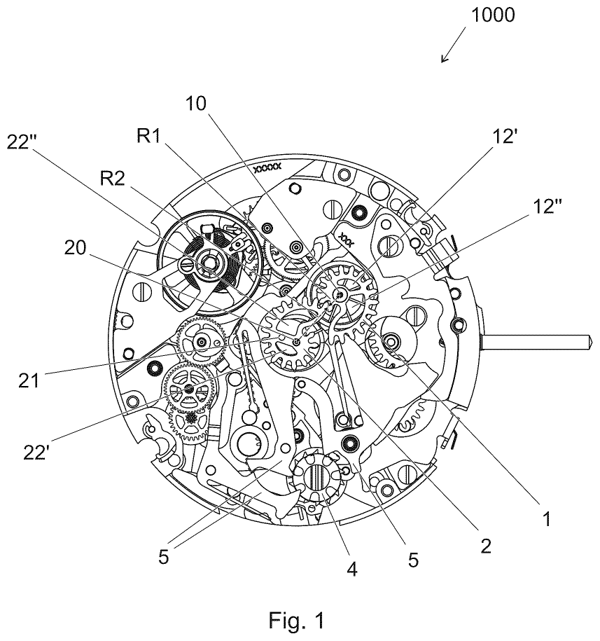

FIG. 1 shows a top view of part of a movement 1000 for one embodiment of the chronograph-watch according to the invention.

In the embodiment illustrated in FIG. 1, this movement 1000 displays the current time in addition to a measured duration. In another embodiment (not illustrated), this movement 1000 does not display the current time.

As the operation of a 1000 chronograph-watch movement (with or without display of the current time) is known per se, it will not be described in detail here. By way of a non-limiting example, the operation of the 1000 chronograph-watch movement shown in FIG. 1 is based on a column wheel 4 which is conventionally connected to levers 5.

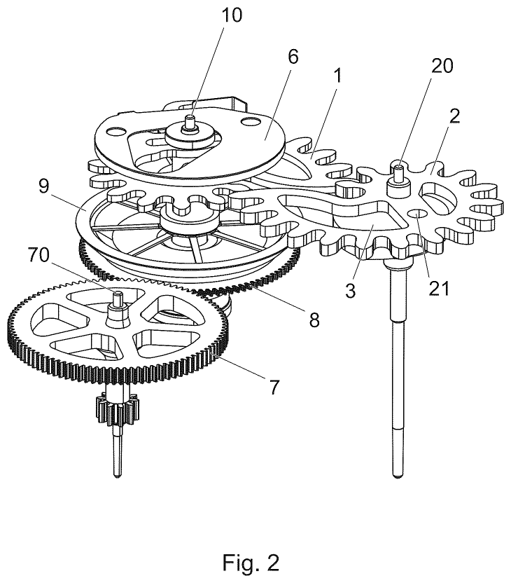

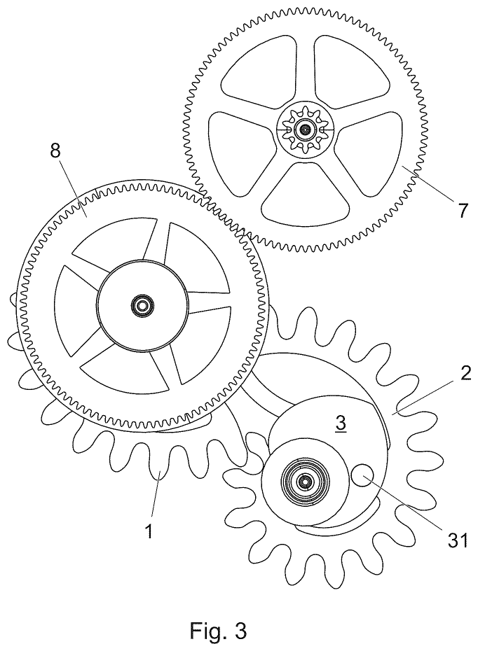

The mechanism, part of which is illustrated in FIGS. 2 and 3, comprises an input mobile 8, comprising an input axis 10 and is arranged to rotate, preferably permanently, about this input axis 10.

In the example shown in FIGS. 2 and 3, this input mobile 8 is driven in rotation by a current time mobile 7 of the kinematic chain enabling the current time to be counted and displayed, i.e. the kinematic chain linking an energy source, for example a barrel, to a regulating organ and to the wheels of the watch, which are linked to the indicator members of the watch in order to display the current hour, minutes and/or seconds. This current time mobile 7 may be, for example, a current second wheel, which is therefore arranged to rotate about its axis 70 at a constant speed of rotation, for example one revolution per minute (or 6° per second). In the example shown, the input mobile 8 also rotates at a constant speed, for example at the same speed of one revolution per minute.

A clutch mechanism is arranged so that, under the action of an actuating device, the input mobile 8 can be connected to the first mobile 1 of the mechanism according to the invention.

The clutch mechanism can be a horizontal or side clutch, a vertical clutch, an oscillating pinion clutch, etc. Since clutch mechanisms are known per se, they will not be described here. By way of example, FIGS. 2 and 3 illustrate a vertical clutch mechanism, comprising a flange 9. Following the user's action on a push-button (not illustrated) of the chronograph-watch, an actuating device (not illustrated) comprising, for example, pliers (not illustrated) enable the flange 9 to be moved along the axis of rotation 10, in order to produce the clutch between the input mobile 8 and the first mobile 1.

Of course, the fact that in the example shown in FIGS. 2 and 3 the axis of rotation of the input mobile 8 corresponds to the axis of rotation 10 of the first mobile 1 is not an essential feature of the invention and depends on the chosen type of clutch.

The first mobile 1 can therefore rotate about the axis 10 at a constant speed when it is connected to the input mobile 8 by the clutch mechanism.

In one embodiment, the speed of rotation of the first mobile 1 is equal to that of the input mobile 8, for example and without limitation it is one revolution per minute. In another embodiment, the speed of rotation of the first mobile 1 is different from that of the input mobile 8, for example it is lower.

The first mobile 1 is therefore a driving mobile which is rotated about its axis of rotation 10 by the user.

The timepiece mechanism 100 according to the invention also comprises a second mobile 2, arranged to mesh with the first mobile 1, and to be connected to an indicator member (not shown in FIGS. 1 to 3).

The second mobile 2 is therefore driven by the first mobile 1. It is rotated about its axis of rotation 20.

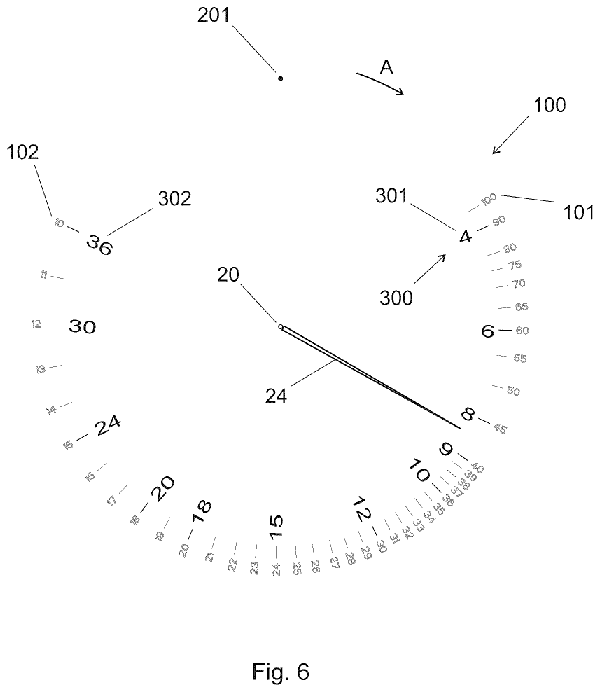

The timepiece mechanism according to the invention also comprises an element (not illustrated in FIGS. 1 to 3), such as for example a dial (or a portion of a dial) or a bezel (or a portion of a bezel) bearing a scale comprising a set of indications, the indicator member allowing to display on this scale information, for example temporal or auxiliary information (such as for example tachometric, pulsometric or telemetric information). Examples of auxiliary indication scales are shown, for example, in FIGS. 6 to 10, which will be discussed later. The scale generally has an arcuate or substantially circular shape. Of course, the scale may have other shapes, for example and not restrictively a spiral shape.

According to the invention, the first mobile 1 and the second mobile 2 are arranged to obtain a gear ratio between the first mobile 1 and the second mobile 2 that varies as a function of their relative angular position, so that the indicator member rotates with a variable speed of rotation, at at least one subset of the set of indications carried by the scale.

In particular, the indicator member rotates at a variable speed of rotation because it is connected to the second mobile 2 which rotates at a variable speed of rotation in correspondence with at least one subset of the set of indications. In a preferred embodiment, the rotational speed of the second mobile 2 corresponds to that of the indicator member. In a preferred embodiment, the indicator member is mounted on the axis of rotation 20 of the second mobile 2.

Thanks to the fact that the indicator member rotates at a variable speed of rotation, at at least one subset of the set of indications carried by the scale, it is possible to design several scales which are more readable than known solutions, while allowing more (or less) detailed (or more or less precise) information to be displayed for one or more subsets of the set of indications concerned.

In a preferred embodiment, the first mobile 1 and the second mobile 2 have the same shape. In another embodiment, the first mobile 1 and the second mobile 2 have different shapes.

In a preferred embodiment, this shape is defined by radii of different lengths, the first mobile 1 and the second mobile 2 being arranged so that the sum of the radii R1, R2 of each mobile 1, 2 in correspondence of the gearing of the two mobiles is constant, as seen for example in FIG. 1.

Advantageously, the sum of these radii R1 and R2 is equal to the distance between the axes of the two mobiles 1 and 2, i.e. the distance between the axis of rotation of the first mobile 10 and the axis of rotation 20 of the second mobile.

In one embodiment, the sum of these radii R1 and R² is in the range 3 mm to 8 mm, preferably 5 mm to 6 mm, in particular 5.436 mm to 5.450 mm.

In one embodiment, the first mobile 1 and the second mobile 2 have the same perimeter. In another embodiment, the perimeter of the first mobile 1 is a multiple of the perimeter of the second mobile 2. In another embodiment, the perimeter of the second mobile 2 is a multiple of the perimeter of the first mobile 1.

Thanks to the timepiece mechanism according to the invention, it is thus possible to design several display possibilities, according to the needs of specific applications, while improving the readability of the information for the user, at least in the subset(s) of interest of the indications carried by the scale, according to the desired application.

In the embodiment shown in FIGS. 1 to 3, each of the first mobile 1 and the second mobile 2 is a spiral-shaped cam.

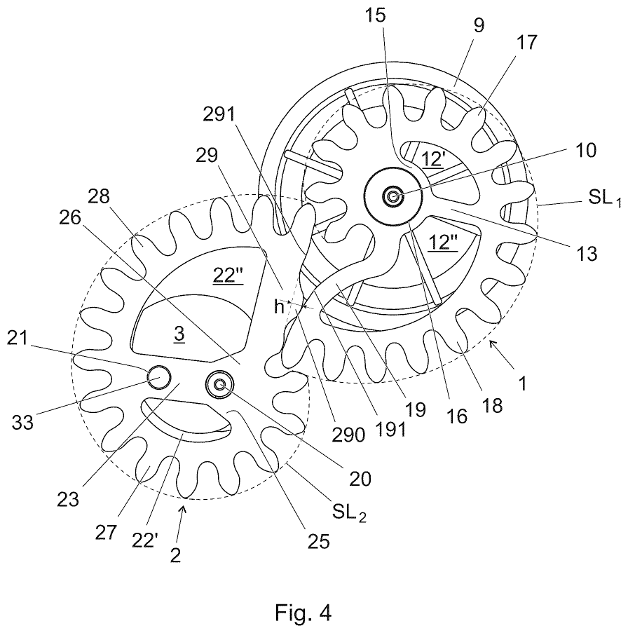

In one embodiment, an example of which can be seen in FIG. 4, each of the first and second mobiles has a logarithmic spiral shape, i.e. the shape defined by the vertices of the teeth of each mobile is a portion of a logarithmic spiral SL₁, SL₂. In one embodiment, this logarithmic spiral shape is the same for the first mobile and the second mobile.

The logarithmic spiral shape of each mobile allows to limit variations in the speed of the indicator member, particularly for a given period, for example less than 1 minute from start-up. The curve of the speed of the indicator member as a function of time in this period is therefore a smooth curve, with no peaks. The logarithmic spiral shape of each mobile also gives a logarithmic curve of the torque of the indicator member as a function of time, and therefore without peaks.

In one embodiment, each of the first mobile 1 and the second mobile 2 comprises a mobile body and a toothing.

In one embodiment, each of the first mobile 1 and second mobile 2 comprises at least one recess, in order to reduce its unbalance when the indicator member is reset.

In one embodiment, each mobile having a logarithmic spiral shape comprises a first recess (reference 12′ for the first mobile 1 and reference 22′ for the second mobile 2) and a second recess (reference 12″ for the first mobile 1 and reference 22″ for the second mobile 2).

In one embodiment, each first recess 12′, 22′ is defined by a first proximal portion 15, 25 of the body of the mobile 1 respectively 2, namely a portion close to the axis of rotation of the mobile, by a first portion 17, 27 of the toothing of the mobile and by a first arm 13, 23, the first arm connecting one end of the first proximal portion 15, 25 of the body of the mobile to one end of the first portion 17, 27 of the toothing of the mobile 1 respectively 2.

In one embodiment, each second recess 12″, 22″ is defined by a second proximal portion 16, 26 of the body of the mobile 1 respectively 2 (adjacent to the first proximal portion 15, 25), by the first arm 13, 23, by a second portion 18, 28 of the toothing of the mobile 1 respectively 2 and by a second arm 19, 29, the second arm 19, 29 connecting one end of the toothing to one end of the second proximal portion 16, 26 of the body of the mobile 1 respectively 2.

In one embodiment, the shape and/or dimensions of the first recess 12′ of the first mobile 1 is/are different from the shape and/or dimensions of the first recess 22′ of the second mobile 2. In one embodiment, the shape and/or dimensions of the second recess 12″ of the first mobile 1 is/are different from the shape and/or dimensions of the second recess 22″ of the second mobile 2.

In one embodiment, the shape and/or dimensions of the first arm 13 of the first mobile 1 is/are different from the shape and/or dimensions of the first arm 23 of the second mobile 2. In one embodiment, the shape and/or dimensions of the second arm 19 of the first mobile 1 is/are different from the shape and/or dimensions of the second arm 29 of the second mobile 2.

The logarithmic spiral shape SL₁, SL₂ of each mobile also allows to have a greater maximum value of torque (of the driven mobile) compared with the maximum value of torque obtained with a circular shape of each mobile. In one embodiment, the logarithmic spiral shape SL₁, SL₂ of each mobile also allows the maximum value of the torque (of the driven mobile) to be three times that obtained with a circular shape of each mobile.

In one embodiment, when the user starts the indicator member reset, the second mobile 2 is no longer a driven mobile, but becomes a driving mobile. During the reset, the second mobile 2 leads the first mobile 1 and, via the first mobile, also the input mobile 8.

In one embodiment, the timepiece mechanism comprises a heart piece 3 coaxial with the second mobile 2.

The maximum value of the torque of the larger driven mobile obtained by the logarithmic spiral shape of the mobile s, combined with the friction of the input mobile, can cause a disengagement between the second mobile 2 and the heart piece 3, thus creating an offset between the rotation of the heart piece 3 and that of the second mobile 2 and therefore an offset of the indicator member in relation to the dial when the timepiece mechanism is activated at start-up.

In one embodiment, the timepiece mechanism therefore comprises a connecting means between the second mobile 2 and the heart piece 3, enabling them to be made integral, and therefore avoiding any shift caused during the reset. In one embodiment, this connecting means comprises a pin 33, visible in FIG. 4, carried by the heart piece 3 and arranged to be received by a through hole in the second mobile 2. In the embodiment shown in FIG. 4, the first arm 23 of the second mobile 3 comprises this through hole 21. In one embodiment, this through hole 21 is also a means of indexing the heart piece 3.

In another embodiment (not shown), the second mobile 2 and the heart piece 3 form a monobloc piece, i.e. a piece made in a monolithic way. This also allows to secure the second mobile 2 to the heart piece 3, and thus avoid any displacement caused during the reset.

In one embodiment, the shape of the heart piece 3 is optimised to compensate for the effects of the logarithmic spiral shape of the second mobile 2, to enable the indicator member to be reset.

If there is (angular) play between the two mobiles 1, 2, which allows the second mobile 2 to rotate before it is driven by the first mobile 1, it is possible to observe a backward movement of the indicator member at the start of the chronograph-watch, in particular a backward movement of the order of magnitude of a few degrees (for example 3.5°) counter-clockwise with respect to the starting position of the indicator member.

To reduce or eliminate this play, in one embodiment the timepiece mechanism also comprises play-limiting means between the two mobiles 1, 2. In the embodiment shown in FIG. 4, the second arm 29 of the second mobile 2 comprises this play-limiting means in the form of a protrusion 290 of the second arm 29.

In one embodiment, this protrusion 290 is arranged so that it comes into contact with the arm 19 of the first mobile 1, and in particular with the outer surface 191 of this arm 19, before the second mobile 2 is driven by the first mobile 1 via their respective toothing. The outer surface 191 of the arm 19 is that distal from the opening 12″.

In one embodiment, this protrusion 290 is a protuberance of the outer surface 291 of the arm 29, directed towards the first mobile 1. In one embodiment, this protrusion 290 has a bumpy or rounded shape. In one embodiment, the maximum height h of this protrusion 290 is less than the height of the teeth of the first mobile 1 and/or second mobile 2.

In one embodiment, this protrusion 290 is positioned so that it comes into contact with the end of the arm 19 which is distal from the centre of rotation 10, namely the end of the arm 19 close to the toothing (and in particular an end tooth) of the first mobile 1. In one embodiment, this protrusion 290 is placed substantially in correspondence with the central part of the outer surface 291 of the arm 29.

In one embodiment, the protrusion 290 and the arm 29 form a monobloc piece, i.e. a piece made monolithically. In another embodiment, the protuberance 290 and the arm 29 are two separate parts connected together by (movable or removable) connecting means.

In another embodiment, the first and second mobiles 1, 2 have a shape other than a spiral, and instead resemble a potato-shaped or toothed cam.

In general, the shape of the first and second mobiles 1, 2 can be calculated by a calculation module, considering the desired rotation speed constraints in the subsets of the scale of interest and/or in the corresponding measured time interval, the constraint that the sum of the radii of each mobile in correspondence of the gearing of the two mobiles is constant, the sum of these radii being equal to the inter-axis of the two mobiles 1 and 2 and one of the constraints on the perimeter of the two mobiles.

In one embodiment, the timepiece mechanism according to the invention comprises a heart piece 3 coaxial with the second mobile 2 (visible in FIGS. 2 and 3).

In one embodiment, the second mobile 2 and/or the heart piece 3 comprise means for indexing this heart piece, for example the through hole 21 in FIG. 2 (better visible in FIG. 2) or the through hole 31 in FIG. 3, which must be aligned to enable this indexing.

In one embodiment, the toothing of the first mobile and/or the second mobile are arranged to reduce overlapping of the indicator member.

In the embodiment in which the first mobile 1 rotates at a speed that enables a time to be counted in seconds, for example at a speed of one revolution per minute, it can be connected to an element such as the plate 6 shown in FIG. 2, which enables another measured time mobile, for example the measured minutes mobile, to be rotated, for example by means of a spring. In turn, the measured minutes mobile can be connected to an element similar to the plate 6 in FIG. 2, which enables another measured time mobile, for example the measured hours mobile, to be rotated in a similar way.

When the user starts the rotation of the indicator member, the input mobile 8 leads the first mobile 1 and therefore the second mobile 2. In one embodiment, when the user starts the reset of the indicator member, the second mobile 2—via the first mobile 1—leads the input mobile 8, following the action of a hammer (not illustrated) on the heart piece 3.

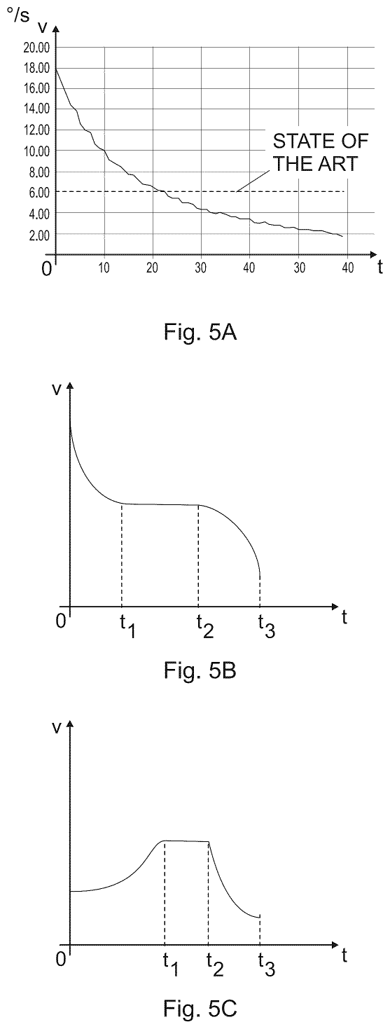

FIG. 5A is a graph illustrating the variation over time of the speed v of rotation of the indicator member of the timepiece mechanism according to one embodiment of the invention, in relation to a constant speed of known solutions, which in general is 6° per second. In the example shown, the speed of rotation, which is greater than 6° per second when the indicator member is started, decreases with a law of decrease, for example a logarithmic law of decrease, in the range 0-t₃, t₃ being 60 seconds for example.

FIGS. 5B and 5C are also graphs illustrating the variation over time of the speed of rotation of the indicator member of the timepiece mechanism according to other embodiments of the invention.

In the example shown in FIG. 5B, the speed of rotation decreases according to a first law in the range 0-t₁ (which corresponds, for example, to a first subset of the set of indications), it remains constant in the range t₁-t₂ (which corresponds, for example, to a second subset of the set of indications) and it decreases according to a second law in the range

t₂-t₃ (which corresponds, for example, to a third subset of the set of indications).

In the example shown in FIG. 5C, the speed of rotation increases in the range 0-t₁ (which corresponds, for example, to a first subset of the set of indications), remains constant in the range t₁-t₂ (which corresponds, for example, to a second subset of the set of indications) and decreases in the range t₂-t₃ (which corresponds, for example, to a third subset of the set of indications).

The timepiece mechanism according to the invention allows therefore to design several speed profiles for the indicator member. This, combined with a scale of indications (temporal or auxiliary) with a constant or variable distance between one indication and the next, enables the user to have more or less detailed information for one or more subsets of the desired set of indications, with better readability than known solutions.

In one embodiment, the scale of the mechanism according to the invention is a time scale, bearing indications of measured time, for example measured seconds, minutes or hours. In one embodiment, the first mobile and the second mobile are arranged to enable the user to read the time more accurately in at least one subset of the set of indications carried by this scale. In a preferred embodiment, this subset corresponds to the

0 seconds-10 seconds interval of the measured seconds.

In one embodiment, the timepiece mechanism according to the invention carries a tachometric scale.

FIG. 6 illustrates a top view of an embodiment of a tachometric scale 100 of the timepiece mechanism according to the invention. In this embodiment, the mechanism according to the invention also includes a measured time scale 300, for example of measured seconds.

In the embodiment shown in FIG. 6, the tachometric scale 100 and the measured seconds scale 300 share the same graduation signs, the numerical values of the tachometric scale 100 being arranged on an outer arc of a circle and those of the measured seconds scale 300 being arranged on an inner arc of a circle, the two arcs of a circle having the same centre 20.

This tachymetric scale 100 is particularly suitable for an athlete who runs over a distance of 100 m and carries average speed indications over this distance, measured in km/h. It carries an initial auxiliary indication 101 of 100 km/h (this value not being limitative), a final auxiliary indication 102 of 10 km/h (this value not being limitative either) and intermediate auxiliary indications between the two. Of course, the initial, final and intermediate auxiliary indications are given by way of example and are not limitative. This applies to all the scales illustrated in FIGS. 6 to 10.

As can be seen in FIG. 6, the auxiliary indications have a variable distance between one indication and the next. In the example shown, they are spaced 10 km/h apart in the subset between 100 km/h and 80 km/h, the distance between an indication and the next one in this first subset being increasingly greater; 5 km/h apart in the subset between 80 km/h and 40 km/h, the distance between an indication and the next one in this second subset also being increasingly greater, and finally they are spaced 1 km/h apart in the subset between 40 km/h and 10 km/h, the distance between an indication and the next one in this third subset being increasingly greater.

The scale 100 has the shape of an arc of a circle, with its centre at the axis of rotation 20. The indicator member, which is arranged to rotate around the axis of rotation 20, at rest has one end at twelve o'clock. Corresponding to this angular position, indicated by reference 201, the measured time scale 300 generally carries an initial indication of the measured time (not illustrated), for example 0 seconds.

When a push-button (or other control device) on the chronograph-watch is first pressed, the indicator member starts rotating in the direction indicated by arrow A.

The first and second mobiles 1 and 2, which cooperate with the scale 100 of FIG. 6 in one embodiment, are arranged so that the indicator member rotates at a decreasing speed as the indicator member rotates.

In this embodiment, the first and second mobiles 1, 2 can have a spiral shape, for example a logarithmic spiral.

Pressing a second time the same push-button or another push-button stops the indicator member at the precise point where it was when the push-button was pressed.

The scale 100 of FIG. 6, combined with the variable speed of rotation of the mechanism according to the invention, allows to have—at the subsets of indications of interest for the envisaged application-(variable) distances between one indication and the next which are larger than the corresponding distances (also variable) of known solutions, which allows to have better readability and resolution of the desired information in correspondence with the stop point of the indicator member with regard to known solutions.

This scale 100, combined with the variable speed of rotation of the mechanism according to the invention, also allows to have—at subsets of indications which are not of interest for the application envisaged-(variable) distances between one indication and the next which are smaller than the corresponding distances (also variable) of known solutions.

This provides a parameterised level of detail for the different sub-assemblies depending on the application of interest, while making the desired information easier to read compared to known solutions.

As can be seen in FIG. 6, the indications on the timer scale 300 also have a variable distance between one indication and the next.

The initial indication 301 of the measured time scale 300 in the embodiment of FIG. 6 is offset with respect to the initial indication 101 of the tachometric scale 100, and the final indication 302 of the measured time scale 300 shares the same graduation sign as the final indication 102 of the tachometric scale 100. However, this embodiment is not limitative and any other arrangement of the indications of the two scales may be envisaged. This also applies to the embodiments of FIGS. 6 to 10.

The measured seconds scale 300 of FIG. 6, combined with the variable rotation speed of the mechanism according to the invention, also allows to have—at the subsets of indications of interest for the envisaged application-(variable) distances between one indication and the following one which have larger dimensions than the corresponding distances (also variable) of the known solutions, which allows a better readability and resolution of the desired information in correspondence of the stop point of the indicating organ compared to the known solutions.

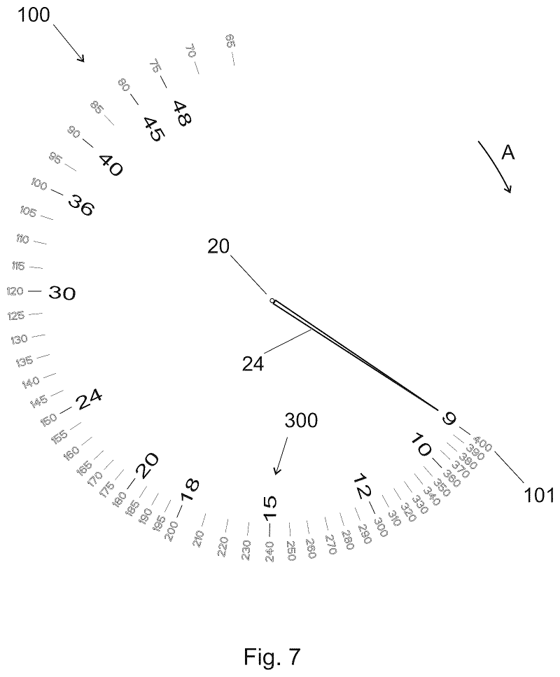

FIG. 7 illustrates a top view of an embodiment of a scale 100 of the timepiece mechanism according to the invention, in particular a 1000 m tachymeter scale. In this embodiment, the mechanism according to the invention also includes a measured time scale 300, for example of measured seconds.

Also in the embodiment shown in FIG. 7, the tachometric scale 100 and the measured seconds scale 300 share the same graduation signs, the numerical values of the tachometric scale 100 being arranged on an outer arc of a circle and those of the measured seconds scale 300 being arranged on an inner arc of a circle, the two arcs of a circle having the same centre 20.

This tachymeter scale 100 is particularly suitable for a car which travels a distance of 1000 m (for example between two levels on a motorway) and carries average speed indications over this distance, measured in km/h. It carries an initial auxiliary indication 101 of

400 km/h, a final auxiliary indication 102 of 60 km/h and intermediate auxiliary indications between the two.

As can be seen in FIG. 7, the auxiliary indications are spaced by 10 km/h in the subset between 400 km/h and 200 km/h, the distance between one indication and the next in this first subset being increasingly greater, and by 5 km/h in the subset between 200 km/h and 60 km/h, the distance between one indication and the next in this second subset also being increasingly greater.

The scale 100 has the shape of an arc of a circle, having its centre at the axis of rotation 20. The indicator member, which is arranged to rotate about the axis of rotation 20, at rest has an end at twelve o'clock, where there is also the auxiliary final indication 102.

When a push-button (or other control device) on the chronograph-watch is first pressed, the indicator member starts to rotate in the direction indicated by arrow A.

The first and second mobiles 1 and 2, which cooperate with the scale 100 of FIG. 7 in one embodiment, are arranged so that the indicator member rotates at a decreasing speed as the indicator member rotates.

In this embodiment, the first and second mobiles 1, 2 can also have a spiral shape, for example a logarithmic spiral.

Pressing a second time the same push-button or another push-button stops the indicator member at the precise point where it was when the push-button was pressed.

As with the scale in FIG. 6, the 100 scale in FIG. 7 has a customised level of detail for the different sub-assemblies depending on the application of interest, while allowing better readability of the desired information compared with known solutions.

As with the scale in FIG. 6, the measured time scale 300 in FIG. 7 has a customised level of detail for different sub-assemblies, while allowing better readability of the desired information compared with known solutions.

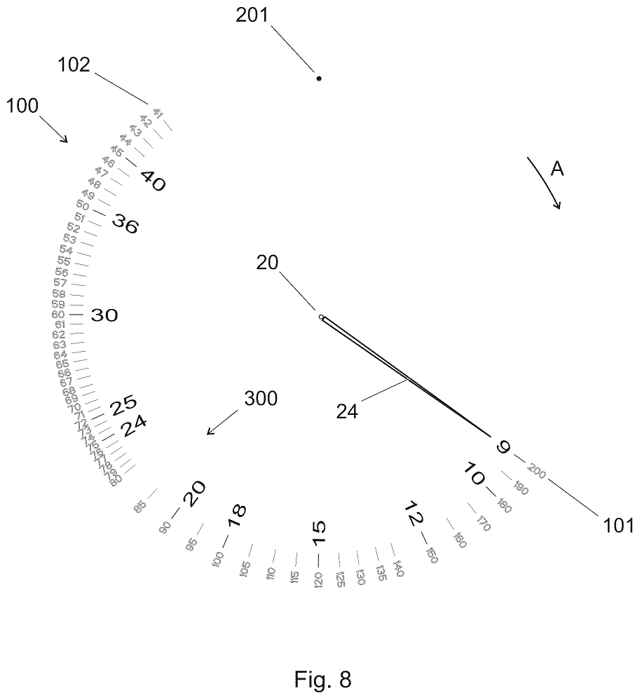

FIG. 8 illustrates a top view of an embodiment of a scale 100 of the timepiece mechanism according to the invention, in particular a pulsometric scale for 30 pulses. This scale 100 is particularly suitable for calculating the heart rate of a sportsperson. In this embodiment, the mechanism according to the invention also comprises a measured time scale 300, for example measured seconds.

Also in the embodiment shown in FIG. 8, the pulsometric scale 100 and the measured seconds scale 300 share the same graduation signs, the numerical values of the pulsometric scale 100 being arranged on an outer arc of a circle and those of the measured seconds scale 300 being arranged on an inner arc of a circle, the two arcs of a circle having the same centre 20.

This pulsometric scale 100 carries heart rate indications, measured in number of pulses per minute (puls/min). It has an initial auxiliary indication 101 of 200 pulses/min, a final auxiliary indication 102 of 41 pulses/min and intermediate auxiliary indications in between.

As can be seen in FIG. 8, the auxiliary indications are spaced 10 pulses/min apart in the subset between 200 pulses/min and 140 pulses/min, the distance between an indication and the next one in this first subset being increasingly greater, 5 pulses/min in the subset between 140 pulses/min and 80 pulses/min, the distance between an indication and the next one in this second sub-assembly also being increasingly greater and of 1 puls/min in the sub-assembly between 80 puls/min and 41 puls/min, the distance between an indication and the next one in this third sub-assembly also being increasingly greater.

The scale 100 has the shape of an arc of a circle, with its centre at the axis of rotation 20. The indicator member, which is arranged to rotate about the axis of rotation 20, at rest has one end at twelve o'clock. Corresponding to this angular position, indicated by reference 201, the measured time scale 300 generally carries an initial indication of the measured time (not illustrated), for example 0 seconds.

When a push-button (or other control device) on the chronograph-watch is pressed for the first time, the indicator member starts to rotate in the direction indicated by arrow A.

The first and second mobiles 1 and 2, which cooperate with the scale 100 of FIG. 8 in one embodiment, are arranged so that the indicator member rotates at a decreasing speed as the indicator member rotates.

In this embodiment, the first and second mobiles 1, 2 can have a spiral shape, for example a logarithmic spiral.

Pressing a second time the same push-button or another push-button stops the indicator member at the precise point where it was when the plunger was pressed.

The scale 100 of FIG. 8, combined with the variable speed of rotation of the mechanism according to the invention, allows to have—at the subsets of indications of interest for the application envisaged-(variable) distances between one indication and the following ones which are larger than the corresponding distances of the known solutions, which allows to have better readability and resolution of the desired information in correspondence with the stopping point of the indicator member compared with the known solutions.

This scale 100, combined with the variable speed of rotation of the mechanism according to the invention, also allows to have—at subsets of indications which are not of interest for the application envisaged-distances between one indication and the next (variable) which have smaller dimensions than the corresponding distances of the known solutions.

This provides a parameterised level of detail for the various sub-assemblies depending on the application of interest, while making the desired information easier to read compared to known solutions.

The measured time scale 300 in FIG. 8 also has a customised level of detail for different sub-assemblies, while allowing better readability of the desired information compared to known solutions.

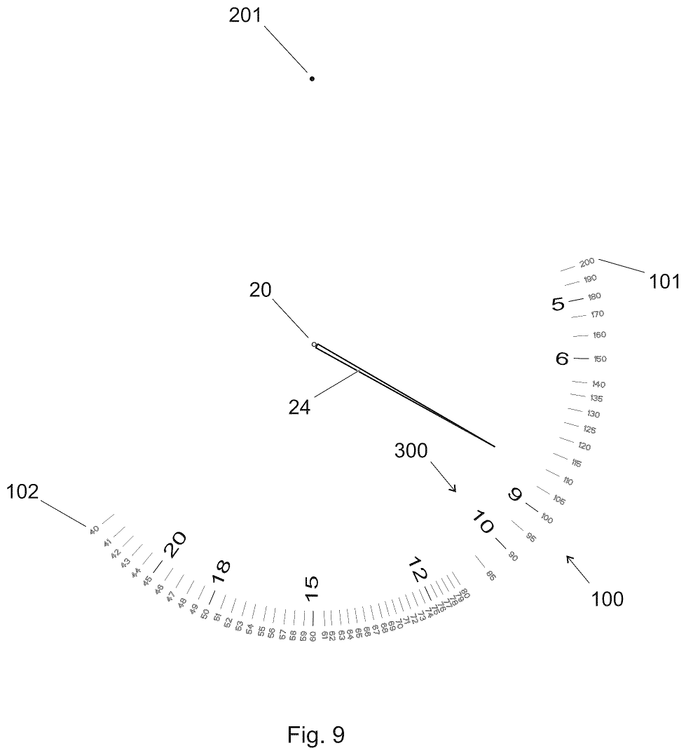

FIG. 9 illustrates a top view of an embodiment of a scale 100 of the timepiece mechanism according to the invention, in particular a pulsometric scale for 15 pulses. This scale 100 is also particularly suitable for calculating the heart rate of a sportsperson. In this embodiment, the mechanism according to the invention also comprises a measured time scale 300, for example measured seconds.

Also in the embodiment shown in FIG. 9, the pulsometric scale 100 and the measured seconds scale 300 share the same graduation signs, the numerical values of the pulsometric scale 100 being arranged on an outer arc of a circle and those of the measured seconds scale 300 being arranged on an inner arc of a circle, the two arcs of a circle having the same centre 20.

This pulsometric scale 100 carries heart rate indications, measured in number of pulses per minute (puls/min). It has an initial auxiliary indication 101 of 200 pulses/min, a final auxiliary indication 102 of 40 pulses/min and intermediate auxiliary indications in between.

The same considerations made for the scale in FIG. 8 apply to that in FIG. 9.

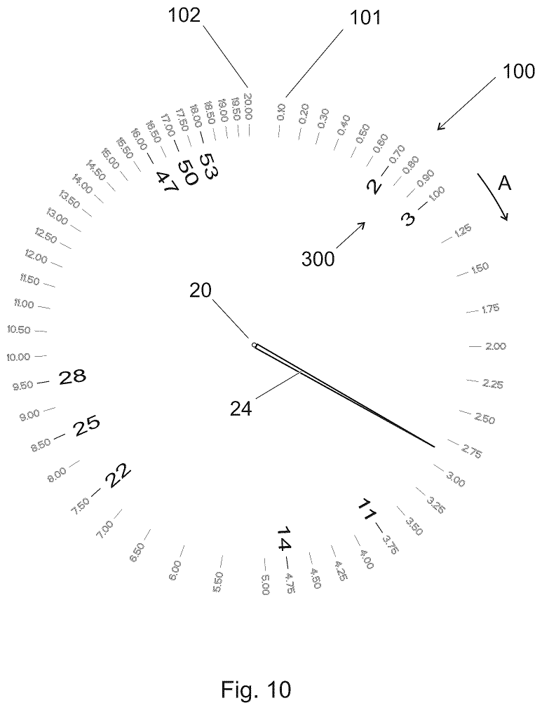

FIG. 10 illustrates a top view of an embodiment of a scale 100 of the timepiece mechanism according to the invention, in particular a telemetric scale. In this embodiment, the mechanism according to the invention also includes a measured time scale 300, for example measured seconds.

Also in the embodiment shown in FIG. 10, the telemetric scale 100 and the measured seconds scale 300 share the same graduation signs, the numerical values of the telemetric scale 100 being arranged on an outer arc of a circle and those of the measured seconds scale 300 being arranged on an inner arc of a circle, the two arcs of a circle having the same centre 20.

This telemetric scale 100 is particularly suitable for calculating a distance in metres. It has an initial auxiliary indication 101 of 0.10 m, a final auxiliary indication 102 of 20.00 m and intermediate auxiliary indications in between. Of course, the initial, final and intermediate auxiliary indications are given by way of example and are not limitative.

As can be seen in FIG. 10, the auxiliary indications are spaced and by 0.10 km in the subset between 0.10 km and 1.00 km, the distance between an indication and the next one in this first subset being constant, by 0.25 km in the subset between 1.00 km and 5.00 km, the distance between an indication and the initial successive indication in this second subset being variable and decreasing in the direction of arrow A, and 0.50 km in the subset between 5.00 km and 20.00 km, the distance between an indication and the successive indication in this third subset being variable with a further decrease in the direction of arrow A.

The indicator member, which is arranged to rotate about an axis of rotation, which generally corresponds to the axis of rotation 20 of the second mobile 20 and which passes through the centre of the circle one arc of which carries the scale 100, at rest has an end corresponding to twelve o'clock.

When a push-button (or other control device) on the chronograph-watch is pressed for the first time, the indicator member starts to rotate in the direction indicated by arrow A.

The first and second mobiles 1 and 2, which cooperate with the scale 100 of FIG. 10 in one embodiment, are arranged so that the indicator member rotates at a decreasing speed as the indicator member rotates.

In this embodiment, the first and second mobiles 1, 2 can have a spiral shape, for example a logarithmic spiral.

Although FIGS. 6 to 10 show examples of scales bearing both specific auxiliary indications and time indications, the invention should not be limited to such scales but also applies to scales without time indications or without auxiliary indications as well as to other scales bearing other auxiliary and/or time indications or with an arrangement different from that illustrated in FIGS. 6 to 10.

With the mechanism described in the invention, it is also possible to use a scale with a constant distance between one indication and the next.

### REFERENCE NUMBERS USED IN FIGURE

1 First mobile
2 Second mobile
3 Heart
4 Column wheel
5 Lever
6 Plate
7 Mobile of current time
8 Input mobile
9 Flange
10 Axis of rotation of the first mobile
12′ First recess of the first mobile
12″ Second recess of the first mobile
13 First arm of the first mobile
15 First proximal portion of the first mobile
16 Second proximal portion of the first mobile
17 First portion of the teeth of the first mobile
18 Second portion of the teeth of the first mobile
19 Second of the first mobile
20 Axis of rotation of the second mobile
21 Indexing hole
22 First recess of the second mobile
22″ Second recess of the second mobile
23 First arm of the second mobile
24 Indicator member
25 First proximal portion of the second mobile
26 Second proximal portion of the second mobile
27 First portion of the teeth of the second mobile
28 Second portion of the teeth of the second mobile
29 Second arm of the second mobile
31 Indexing hole
33 Pin
61 Initial indication
62 Final indication
70 Current time axis
100 Auxiliary indications scale
101 Initial auxiliary indication
102 Final auxiliary indication
103 Indicator member shutdown condition
191 Outside surface of arm 19
201 Angular position 12h
290 Protrusion
291 External surface of arm 29
300 Scale of time indications
301 Initial time indication
302 Final time indication
1000 Movement
A Direction of rotation of the indicator member
h Maximum height of the protrusion
R1 Radius of the first mobile at the mesh with the second mobile
R2 Radius of the second mobile at the mesh with the first gear
SL₁ First logarithmic spiral shape
SL₂ Second logarithmic spiral shape
tᵢ Time
V Indicator member rotation speed

What is claimed is:

1. Chronograph-watch comprising a timepiece mechanism, the timepiece mechanism comprising:
a current time mobile, comprising an axis and being arranged to rotate about this axis;
a first mobile, comprising a first axis and being arranged to be connected to the current time mobile and to rotate about this first axis with a constant speed of rotation,
an indicator member;
a second mobile, arranged to mesh with the first mobile, and to be connected to the said indicator member;
an element bearing a scale comprising a set of indications, said indicator member allowing to display information on this scale;
an actuating device; and
a clutch mechanism, arranged so as to be able to connect the current time mobile with the first mobile under the action of the actuating device,
wherein the first mobile and the second mobile are arranged so as to obtain a gear ratio between the first mobile and the second mobile which varies as a function of their relative angular position, so that the indicator member rotates with a variable speed of rotation in correspondence with at least one subset of said set of indications.

2. Chronograph-watch according to claim 1, comprising:
an input mobile, comprising an input axis and being arranged to rotate about this input axis, the input mobile being arranged to be driven in rotation by the current time mobile,
the clutch mechanism being arranged to be able to connect, under the action of the actuating device, the current time mobile with the first mobile via the input mobile.

3. Chronograph-watch according to claim 1, the scale comprising a plurality of indications, the distance between one indication and the next being constant for the entire set of indications.

4. Chronograph-watch according to claim 1, the scale comprising a plurality of indications, the distance between one indication and the next being variable at least for a subset of said set of indications.

5. Chronograph-watch according to claim 1, the scale being a tachometric, pulsometric or telemetric scale.

6. Chronograph-watch according to claim 1, the first mobile and the second mobile having the same shape.

7. Chronograph-watch according to claim 6, said shape being defined by radius of different lengths, the first mobile and the second mobile being arranged in such a way that the sum of the radius of each mobile in correspondence with the gearing of the two mobiles is constant, the sum of these radii being equal to the distance between the axes of the two mobiles.

8. Chronograph-watch according to claim 7, the sum of the radii belonging to the range from 3 mm to 8 mm.

9. Chronograph-watch according to claim 1, said subset of scale indications being a first subset, the set of indications comprising a second subset distinct from the first subset, each of the first mobile and second mobile is arranged so that the rotation of the second mobile remains constant, in correspondence with the second subset of scale indications.

10. Chronograph-watch according to claim 1, in which the first mobile and the second mobile have a logarithmic spiral shape.

11. Chronograph-watch according to claim 1, in which each of the first mobile and second mobile comprises at least one recess, in order to reduce their unbalance when the indicator member is reset to zero.

12. Chronograph-watch according to claim 10, comprising a heart piece coaxial with the second mobile, and a connecting means between the second mobile and the heart piece, allowing to secure them together, and thus to reduce or avoid any offset caused during a reset to zero.

13. Chronograph-watch according to claim 12, the connecting means comprising a pin carried by the heart piece and arranged to be received by a through hole of the second mobile.

14. Chronograph-watch according to claim 10, comprising a play-limiting means between the first mobile and the second mobile-which allows a rotation of the second mobile before it is driven by the first mobile.

15. Chronograph-watch according to claim 14, the second mobile comprising the play-limiting means.

16. Chronograph-watch as claimed in claim 15, the play-limiting means being a protrusion of an arm of the second mobile.
